(19) United States
(12) Patent Application Publication
(10) Pub. No.: US 2007/0039936 A1
(43) Pub. Date: Feb. 22, 2007

(54) COPPER-FREE WIRE FOR GAS-SHIELDED ARC WELDING

(76) Inventors: Jae Hyoung Lee, Changwon-si (KR); Yong Chul Kim, Changwon-si (KR); Hwan Cheol Bang, Changwon-si (KR)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/463,095

(22) Filed: Aug. 8, 2006

(30) Foreign Application Priority Data
Aug. 22, 2005 (KR) 10-2005-76593

(51) Int. Cl. B23K 35/02

(52) U.S. Cl. 219/145.1

(57) ABSTRACT

Disclosed is a copper-free wire for gas-shielded arc welding featuring superior arc stability, excellent deposition efficiency and high melting rate, wherein the wire has a flat-shaped worked surface, and depressions of a negative direction (toward the center of the wire) with respect to the worked surface formed in a circumferential direction of the surface, a ratio of an actual length (dr) of a circular arc to an apparent length of a circular arc (di) (dr/di) lies within a range of 1.015 to 1.515, and a chemical composition ratio {Cu/(Si+Mn+P+S)}×100 lies within a range of 0.10 to 0.80.

### CROSS-REFERENCE TO RELATED APPLICATIONS

This application claims benefit under 35 U.S.C. § 119 from Korean Patent Application No. 10-2005-0076593, filed on Aug. 22, 2005, the entire content of which is incorporated herein by reference.

### BACKGROUND OF THE INVENTION

1. Field of the Invention

The present invention relates to a copper-free wire for semiautomatic welding or automatic welding. More specifically, the present invention relates to a copper-free wire for welding mild steels and high-tension steels, which, in contrast with copper-plated wires, offers superior arc stability under high-speed welding conditions not lower than 100 cm/min (hereinafter referred to as ‘CPM’) of welding speed in low amperage short circuit transfer and which exhibits excellent deposition efficiency and high melting rate under high current welding conditions not lower than 350 A.

2. Description of the Related Art

Welding wires are generally plated on their surfaces with copper in order to ensure properties of the wire, such as conductivity, feedability, corrosion resistance, and the like. In the case where copper is plated on the surface of the wire, it is necessary to form a uniformly plated copper layer on the surface of the wire in order to ensure conductivity, feedability and rust resistance. In the case where copper is non-uniformly plated on the surface of the wire, minute copper flakes are released (or detached) from the surface of the wire due to friction between the wire and the contact tip within a contact tip upon welding, and concentrated on a portion within the contact tip, thereby causing a clogging phenomenon of the contact tip. This clogging phenomenon of the contact tip leads to poor feedability and arc instability, while increasing the amount of spatter formation. In addition to the above-mentioned problem, the copper-plated wire creates harmful wastewater during a plating process, which only aggravates environmental pollution.

In order to solve such problems inclusive of environmental pollution, wires without copper plating formed on the surface thereof, that is, copper-free wires, have been developed. For the copper-plated wire, a thin film of the copper plated layer enables the wire to come in stable contact with the contact tip, thereby providing a relatively stable arc property. However, for the copper-free wire to be used as a proxy for the copper-plated layer, it is necessary to impart specific properties, such as, a stable contact with the contact tip, to the surface layer of the wire.

In response to such demand, the conventional technologies have developed a wire which consist of a bore and an inner portion expanded inside the bottleneck-shaped depressions, and/or cave-shaped depressions extended into the surface layer of the wire, that is, cave-shaped pits comprising a portion which is not illuminated by incident light from the outside. These pits serve to stably anchor a powder-shaped functional coating agent, which must be present on the surface of the wire in order to ensure arc stability and feedability. Additionally, polyisobutene oil is simultaneously used as a supplementary means for stably anchoring the powder-shaped functional coating agent.

In the meantime, the inventors of the present invention have discovered that, since it is essentially impossible to uniformly control the size (volume) of the bottleneck-shaped or cave-shaped pits, that is, an inside volume of the depression, it is impossible to uniformly coat the functional coating agent on the surface of the wire, that is, in the circumferential (360°) direction, only with the bottleneck-shaped or cave-shaped pit and the ratio of the portion length which is not illuminated by the virtual incident light from the outside to the wire reference circular arc length. Accordingly, when the welding process was carried out for an extended period of time, the powder-type functional coating agent was clogged up inside a conduit cable and the contact tip, which gives rise to poor feedability and interrupts the stable contact between the contact tip and the wire, leading to arc instability. Resultantly, the amount of spatter formation was increased. In addition, the powder-type functional coating agent was easily melted and attached or by-products thereof were accumulated particularly onto the front end of the contact tip by resistance heat and radiative heat during welding. Especially, the depressions have bottleneck-shape or cave-shape and therefore degreasing is not performed effectively in the degreasing process after final drawing and the amount of a lubricant residue is increased.

### SUMMARY OF THE INVENTION

To solve at least the above problems and/or disadvantages and to provide at least the advantages described hereinafter, it is, therefore, an object of the present invention to provide a copper-free wire for gas-shielded arc welding, which comes into stable contact with the contact tip without the copper-plated layer on the surface of the wire, so that copper flakes are not clogged in a conduit cable and the contact tip upon welding for a long time, thereby providing excellent arc stability, stable wire feedability and reduction in spatter formation.

Another object of the present invention to provide a copper-free wire having proper chemical components, so that surface tension of the droplet during welding can be reduced which in turn facilitates the droplet transfer in short circuit transfer mode and under high-current welding conditions.

To achieve the above objects and advantages, there is provided a copper-free wire for gas-shielded arc welding, wherein the wire has a flat-shaped worked surface, and depressions of a negative direction (toward the center of the wire) with respect to the worked surface formed in a circumferential direction of the surface; wherein a ratio of an actual length (dr) of a circular arc to an apparent length of a circular arc (di) (dr/di) lies within a range of 1.015 to 1.515; and wherein a chemical composition ratio {Cu/(Si+Mn+P+S)}×100 lies within a range of 0.10 to 0.80.

In an exemplary embodiment, the amount of lubricant residue existing on the wire surface is not greater than 0.50 g per unit kg of the wire mass.

In an exemplary embodiment, the wire surface is coated with a surface treatment agent of 0.03-0.70 g per unit kg of the wire mass, and the surface treatment agent preferably consists of at least one of animal oil, vegetable oil, mineral oil, mixed oil, and synthesized oil.

### BRIEF DESCRIPTION OF THE DRAWINGS

The above aspects and features of the present invention will be more apparent by describing certain embodiments of the present invention with reference to the accompanying drawings, in which:

FIG. 1 is a graph showing the relation between surface tension and a molten metal (solute);

FIG. 2 diagrammatically shows the relation between temperature and surface tension of elements of an alloy;

FIG. 3 is a schematic view showing transfer behavior of a molten metal during arc welding;

FIG. 4 is a graph showing the relation between resistivity and melting rate of a welding wire;

FIGS. 5 and 6 are SEM micrographs, each showing the surface of a wire where a worked surface is not existent, in accordance with one embodiment of the present invention;

FIGS. 7 and 8 are SEM micrographs, each showing the surface of a wire which is entirely formed of a worked surface, in accordance with one embodiment of the present invention;

FIGS. 9 and 10 are SEM micrographs, each showing the surface of a wire according to the present invention, in which the wire surface has a worked surface and depressions formed therein in a negative direction (toward the center of the wire) with respect to the worked surface;

FIG. 11 is an SEM micrograph, showing an image for measuring a length of a subtense (/) required to calculate an apparent length of a circular arc (di), in accordance with one embodiment of the present invention;

FIG. 12 diagrammatically shows the relation among a length of a subtense (/), a radius (r) of a wire, an internal angle (O) of a circle and an apparent length of a circular arc (di); and

FIGS. 13 and 14 are SEM micrographs, showing an image before a measurement of an actual length of an arc and an image after the measurement, respectively, each image being obtained with an image analyzing system according to one embodiment of the present invention.

### DETAILED DESCRIPTION OF THE PREFERRED EMBODIMENTS

Preferred embodiments of the present invention will be described herein below with reference to the accompanying drawings.

As described above, unlike a copper-plated wire of the conventional technologies, a copper-free wire should have specific properties on its surface to act as a proxy for a copper-plated layer, coming into stable contact with a contact tip.

To impart the specific properties on the surface of the wire, the surface of the wire can be classified into three categories, that is, a flat surface only consisting of a worked surface (in the specification, the term “worked surface” means a flat portion formed on the surface of the wire in the circumferential direction by dies upon drawing, when viewing an image of a cross section of the wire at 90 degrees in the longitudinal direction of the wire, which the image is magnified 1,000 times by an SEM), an irregular surface [symbol] where no worked surface exists, and a combined surface consisting of worked surfaces and depressions of the negative direction (toward the center of the wire) with respect to the worked surface formed in the circumferential direction.

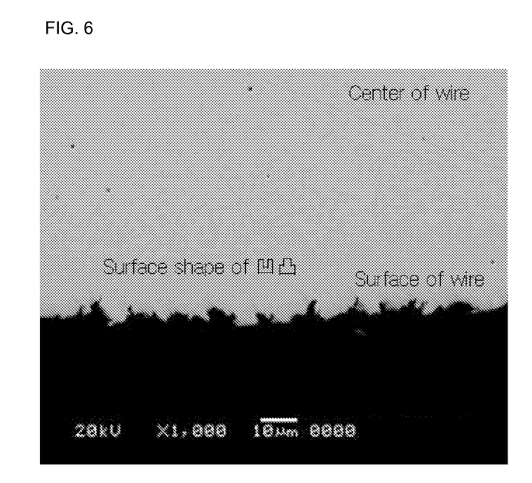

As shown in FIGS. 5 and 6, the irregular surface means a surface where the worked surface is not existent. According to the conventional technologies, the wire has a bore formed on its surface and bottleneck-shaped or cave-shaped pits whose interiors are broader than the bore formed on its cross-sectional surface. However, it corresponds to the irregular surface according to the classification of the present invention.

Although such an irregular surface can offer excellent anchoring capability of a surface treatment agent or a functional coating agent, a stable contact between the contact tip and the wire is not ensured because of the absence of the worked surface and the feedability is deteriorated because friction within a feeding cable during welding increases feeding load. In addition, since degreasing is not performed effectively in the degreasing process after final drawing, the amount of a lubricant residue is increased.

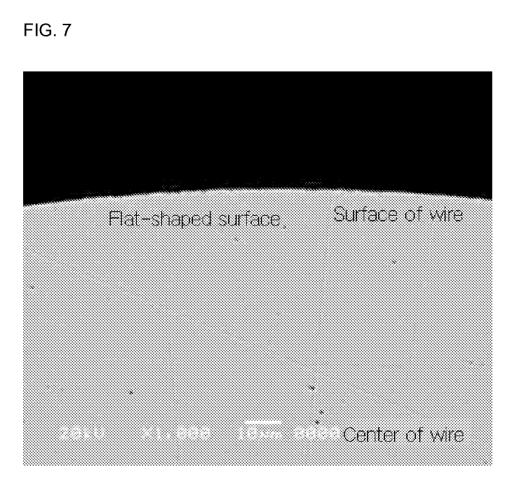

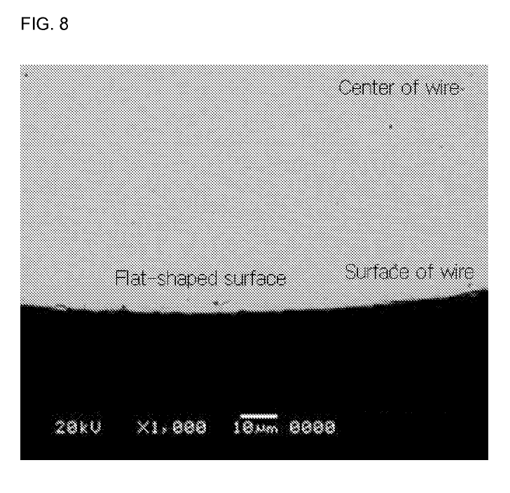

In the meantime, the flat surface as shown in FIGS. 7 and 8 only consists of the worked surface, which ensures a stable contact between the contact tip and the wire. However, the anchoring capability of the surface treatment agent or the functional coating agent is deteriorated, leading to poor feedability due to insufficient lubrication.

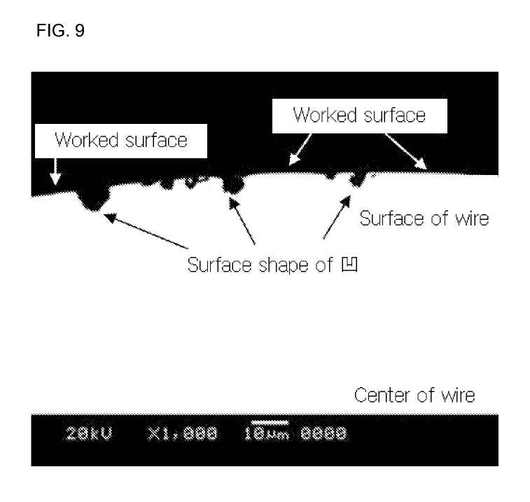

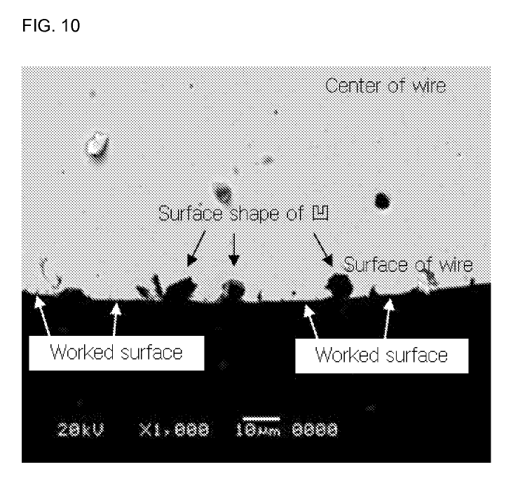

On the contrary, as shown in FIGS. 9 and 10, the combined surface of the wire according to the present invention has the worked surface, which is flat in the circumferential direction, and the depressions formed in the negative direction (toward the center of the wire) with respect to the worked surface, instead of the irregular cross-sectional surface in shape of [symbol] or [symbol] at 90 degrees in the longitudinal direction of the wire. This type of wire surface ensures a stable contact between the contact tip and the wire during welding and provides a stable arc if the ratio of the total length of the worked surface to the measured length in random circumferential direction lies within a proper range, which consequently reduces spatter.

However, modifying the ratio of the total length of the worked surface to a proper range is not enough to effectively reduce the amount of spatter formation during welding. Knowing that the amount of spatter formation during welding increases proportionally to the amount of a lubricant residue, however, setting the ratio of the total length of the worked surface to a proper range is not a perfect way to solve problems related to the amount of the lubricant residue which varies depending on depth, volume and shape of the depressions.

According to the present invention, when the surface of the wire has the combined surface consisting of the worked surface and depressions in the negative direction (toward the center of the wire) with respect to the worked surface formed in the circumferential direction and when the ratio of the actual length (dr) of a circular arc to the apparent length (di) of a circular arc, (dr/di), ranges from 1.015 to 1.515, superior arc stability and excellent weldability can be obtained and the amount of the lubricant residue is reduced

Here, the actual length of a circular arc is obtained by measuring with the image analyzing system an actual length of a circular arc which corresponds to an area to be measured on an image whose cross section at 90 degrees with respect to the longitudinal direction of the wire is magnified 1,000 times by an SEM (i.e., a sum of the circumferential length of depressions formed into the surface of the wire and the length of the worked surface). In addition, the apparent length of a circular arc is a theoretically calculated value of the length of a circular arc corresponding to a real wire diameter at the limited measurement area. This calculation procedure will be explained later.

In the case that the ratio of the actual length of a circular arc to the apparent length of a circular arc (dr/di) is less than 1.015, it is almost impossible to achieve in the real manufacturing process and the wire surface consists of almost entirely of the worked surface like the flat surface. When this occurs, even if a stable contact between the contact tip and the wire may be ensured, the anchoring capability of the surface treatment agent or the functional coating agent is deteriorated, leading to poor feedability due to insufficient lubrication. Meanwhile, in the case that the ratio of the actual length of a circular arc to the apparent length of a circular arc (dr/di) exceeds 1.515, the cross-sectional surface of the wire becomes rough (irregular) and thereby, the anchoring capability of the surface treatment agent is improved. Nevertheless, a stable contact between the contact tip and the wire is not ensured due to lack of the worked surface and the feedability is deteriorated because friction within a feeding cable during welding increases feeding load.

On the other hand, if the ratio of the actual length of a circular arc to the apparent length of a circular arc (dr/di) lies within the range of 1.015 to 1.515 as in the present invention, the cross-sectional surface of the wire becomes smooth and a sufficient worked surface is ensured. Moreover, since the volume of depressions corresponding to the bottleneck or cave shaped portion is reduced, the amount of the lubricant residue also decreases. In this way, a stable contact between the contact tip and the wire during welding is ensured, the amount of the lubricant residue is reduced, and the amount of spatter formation can be reduced substantially.

In the present invention, the amount of the lubricant residue was set to 0.50 g/W·kg or below (weight of the lubricant expressed in grams per unit kg of wire mass). When the amount of the lubricant residue exceeds the present invention limit 0.50 g/W·kg, the amount of spatter formation during welding is increased and thereby, thereby deteriorating arc stability.

The lubricant applied during a drawing process should be removed completely following the last drawing process. The degreasing operation is usually done mechanically or through alkali solution-based degreasing or electrolytic degreasing. The amount of the lubricant residue is affected not only by the degreasing method but also by the shape of depressions formed into the surface of the wire. Especially, if the depressions are formed deeply or have the bottleneck shape or the cave shape, it is very difficult to remove the lubricant.

In the case that the ratio of the actual length of a circular arc to the apparent length of a circular arc (dr/di) falls within the range of 1.015 to 1.515 according to the present invention, it is possible to maintain the amount of the lubricant residue not higher than 0.50 g/W·kg as set in the present invention. However, if the ratio of dr/di exceeds 1.515, although the electrolytic degreasing operation may be carried out, it is still difficult in an in-line system to lower the amount of the lubricant residue to 0.50 g/W·kg or below.

Moreover, according to the present invention, the surface of the wire is coated with 0.03-0.70 g/W·kg of the surface treatment agent. Here, the surface treatment agent serves to impart stable feedability to the wire, thereby further enhancing arc stability.

If less than 0.03 g of the surface treatment agent is present per 1 kg of the wire, sufficient lubrication cannot be ensured due to the excessively low quantity of the surface treatment agent, thereby deteriorating the feedability. On the contrary, if more than 0.70 g of the surface treatment agent is present per 1 kg of wire, feedability is deteriorated due to a slip phenomenon within the feeder section during welding.

In accordance with the present invention, the surface treatment agent consists of at least one of animal oil, vegetable oil, mineral oil, mixed oil, and synthesized oil. When using a powder type surface treatment agent, after long periods of welding, the powdery surface treatment agent is clogged within a conduit cable and the contact tip. However, when using the surface treatment agent of oil type, the accumulation of the surface treatment agent can be avoided, thereby further stabilizing the arc while more effectively suppressing spatter formation.

Unlike copper-plated wires, it is not easy to improve arc stability of copper-free wires during low-amperage high-speed welding or to achieve improved deposition efficiency and melting rate during high-amperage welding. Therefore, inventors examined chemical components of the wire to be able to adjust the surface tension and resistivity of the wire affecting transfer behavior of the wire during welding.

The copper-free wire for gas shield arc welding contains C, Si, Mn, P, S, Cu and Fe as its main ingredient and unavoidable impurities. In order to achieve arc stability during welding, these components were divided into droplet transfer inhibiting factors and droplet transfer motivating factors and limits of their ranges were set, respectively.

The relation between Si, Mn, P, and S as droplet transfer inhibiting factors, and Cu as motivating factor, was studied. The inventors discovered that arc stability in low-amperage short circuit transfer mode and deposition efficiency and melting rate during high-amperage welding were improved when the ratio of {Cu/(Si+Mn+P+S)}×100 was adjusted to fall within the range of 0.10 to 0.80.

Among the elements of the wire composition, C is a main factor of spatter formation during welding. Therefore, the inventors excluded carbon from the wire composition since it is going to damage arc stability contrarily to the object of the present invention.

Moreover, to maximize deposition efficiency, fume, spatter and slag formation substances which lower the deposition efficiency during welding were suppressed as much as possible.

By controlling properties of the surface of the wire, managing the amount of the lubricant residue on the wire surface, and limiting the surface treatment agent to the liquid state, the inventors succeeded to suppress formation of fume, spatter and slag. Particularly, the inventors tried to achieve excellent arc stability by suppressing Cu content, adjusting Si and Mn contents through copper-free wires, and enhanced the deposition efficiency by suppressing the fume, spatter and slag formation substances as much as possible.

The following now describes in detail each component of the wire and its role in composition ratio thereof.

C, 0.03-0.07 wt % (ratio of weight to total weight of wire)

C is an element for improving tensile strength of the deposited metal. However, if the C content in the wire increases the spatter formation during welding increases. When the C content is less than 0.03 wt %, strength of the deposited metal gets weak too much. Meanwhile, when the C content exceeds 0.07 wt %, the spatter formation during welding is increased.

Si: 0.50-1.00 wt %

Si improves fluidity of the molten metal and suppresses spreading of welding beads. In addition, Si is an essential element for ensuring strength of metals and has a deoxidizing effect on the molten metal, thereby forming slag on the molten metal. When the Si content is less than 0.50 wt %, tensile strength of the deposited metal and fluidity of the molten metal are reduced. On the other hand, when the Si content exceeds 1.00 wt %, beads spread during the high current welding process and fluidity of the volume during welding increases, which leads to fluctuation of volume and unstable arc.

Mn: 1.10-1.80 wt %

Mn has a deoxidizing effect like Si, forms slag on the weld metal, and improves strength of the deposited metal. When the Mn content is less than 1.10 wt %, tensile strength and proper surface tension of the deposited metal cannot be ensured. On the other hand, when the Mn content exceeds 1.80 wt %, the quantity of active oxygen in the droplet during welding is reduced and surface tension of the volume is increased.

P: 0.01-0.03 wt %

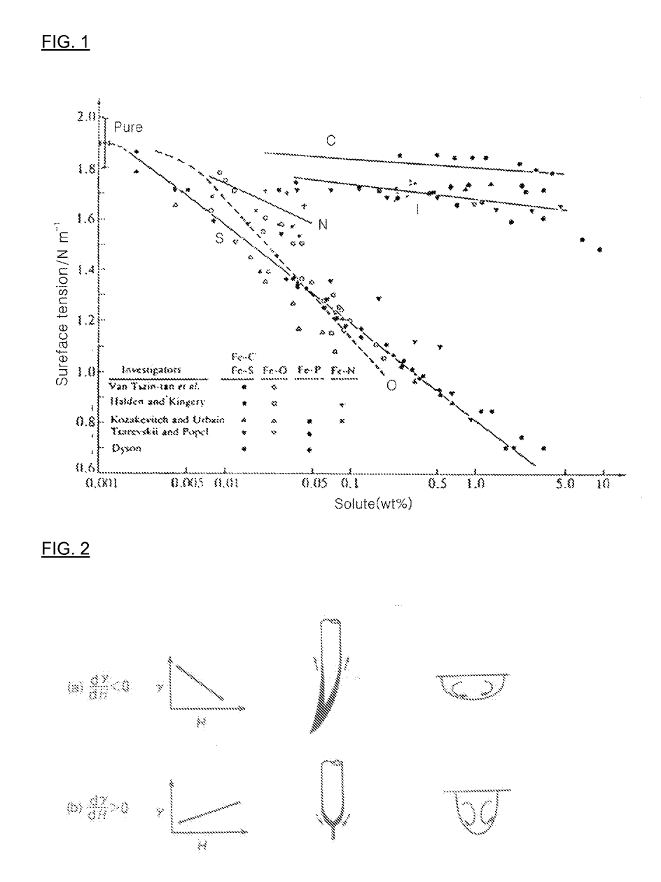

P exists in the metal as an impurity, and produces a low melting point compound and increases high-temperature crack receptivity. However, when the P content in the steel is high, surface tension of the molten metal is reduced as shown in FIG. 1. In detail, when the P content is less than 0.01 wt %, its influence on surface tension of the droplet during welding is insignificant. On the other hand, when the P content exceeds 0.03 wt %, it causes high-temperature cracks.

S: 0.01-0.03 wt %

Similar to P, S produces a low melting point compound and increases high-temperature crack receptivity. However, S, together with O and N, is the representative surface activating element, which lowers surface tension of the molten metal as shown in FIG. 1. When the S content is less than 0.01 wt %, its influence on surface tension of the droplet during welding is insignificant. On the other hand, when the S content exceeds 0.03 wt %, it causes high-temperature cracks.

As shown in FIG. 2, the typical elements of an alloy have lower surface tension as temperature goes up. However, when the surface activating element is added thereto, surface tension thereof increases proportionally to temperature. Thus, a deep penetration should be done and at the same time transfer on the front end of the wire should be facilitated.

Cu: 0.003-0.030 wt %

Cu exists in the steel as an impurity. When plated on the surface, Cu improves conductivity between the wire and the contact tip, but has a role as a surface tension conditioner during welding. When the Cu content is less than 0.003 wt %, it cannot adjust surface tension of the droplet during welding. On the other hand, when the Cu content exceeds 0.030 wt %, surface tension increases too much and it inhibits the droplet transfer.

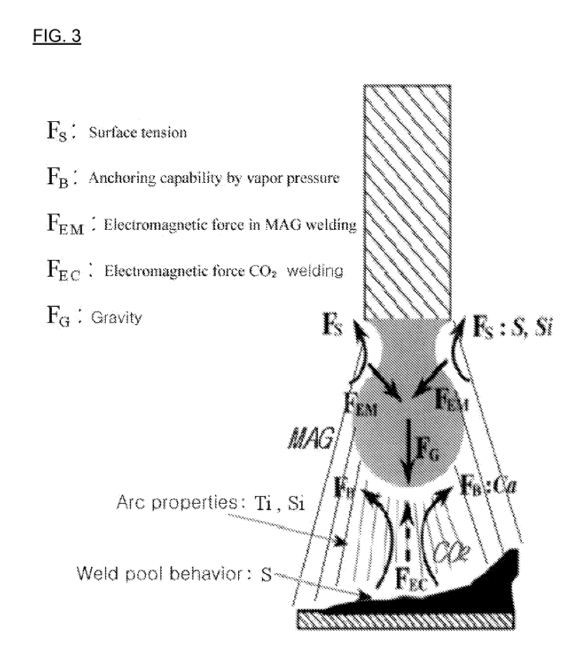

The following now describes transfer phenomenon of the molten metal during arc welding. As shown in FIG. 3, transfer promoting factors include surface tension (F_{S}) of the low molten metal, dead load (gravity, F_{G}) Of droplet of the molten metal, pinch force (F_{EM}) in proportion to the square of welding current. On the other hand, transfer inhibiting factors include arc-carrying capacity (F_{B}) suppressing the transfer on the front end of the droplet with the use of carbon dioxide gas, electromagnetic force (F_{EC}), surface tension (F_{S}) of the high molten metal and the like.

Moreover, the melting rate of the wire during arc welding is controlled by the droplet transfer motivating factor and by resistance heat generated between the wire end and the contact tip. The melting rate can be expressed by the Equation 1 below.
Melting rate=arc heat+resistance heat=aI+bLeI² [Equation 1]
(where, a, b: constant, Le: wire extension, I: welding current)

The resistance heat increases in proportion to the square of current provided from the welding power source during arc welding and to the wire extension from the contact tip to the wire end. The Equation 1 can be expressed in terms of resistance heat to obtain Equation 2 below.
Resistance heat=aLeI² [Equation 2]
(where, a: constant, Le: wire extension, I: welding current)

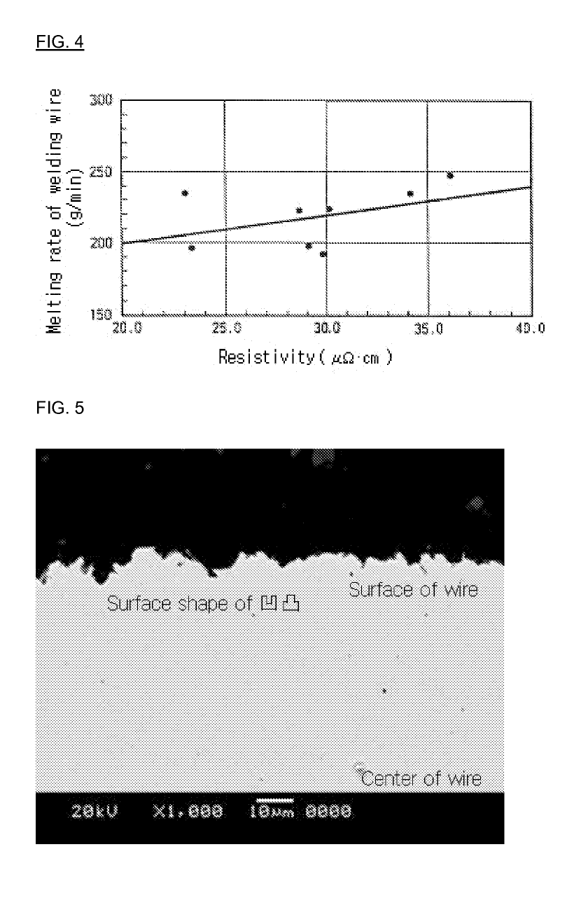

Since the resistance heat increases in proportion to resistivity which is one of intrinsic (inherent) properties of an object, it is apparent that resistivity and resistance heat vary depending on the kinds of welding wires and the status of the surface layer. FIG. 4 illustrates the relation between resistivity and melting rate.

Generally, in case of an electrically conductive metal, free electrons in the metal move actively as its temperature goes up. Naturally, interelectronic collisions occur frequently and many electrons cannot move easily because of that. This leads to an increase in resistance and further an increase in resistivity. Therefore, resistance at the wire end by high-temperature arc heat during welding is greater than resistance at room temperature, and it is rather obvious that resistance at high temperature is even higher if resistance at room temperature is already high.

Accordingly, to control the surface properties of the wire which determine the quality of the manufacturing processes and at the same time to combine the droplet transfer motivating factors and the wire melting rate facilitating factors, the inventors limited contents of Si, Mn, P, and S to specific ranges and carried out optimal experiments repeatedly. Nevertheless, they failed to impart the typical role of a copper-plated layer of the traditional copper-plated wires, i.e., adjustment of conductivity and surface tension, to the copper-free wires. Thus, as a conditioner of surface tension, the ratio of the Cu component to the melting rate control components Si, Mn, P, and S, {Cu/(Si+Mn+P+S)}×100 was managed to fall within the range of 0.10 to 0.80. In this manner, the inventors could motivate the transfer of droplet in low-amperage short circuit transfer mode and thereby, facilitated high-speed welding. In addition, the inventors could obtain copper-free wires for gas shielded arc welding, which stabilizes the droplet transfer during high-amperage welding.

Here, if the value of {Cu/(Si+Mn+P+S)}×100 is less than 0.10, it means the denominator (Si+Mn+P+S) content is greater. In other words, steel contains a large amount of impurities, i.e., P and S, or a large amount of deoxidizers, i.e., Si and Mn. When the content of P and S forming a low-melting point compound is high, it is difficult to properly control the surface tension and the risk of generating high-temperature cracks during welding is increased. Similarly, if the content of Si and Mn is high, the surface tension increases and smooth droplet transfer is not easily achieved.

On the other hand, if the value of the ratio exceeds 0.80, it means the denominator (Si+Mn+P+S) content is small or the numerator Cu content is large value. Since the present invention relates to copper-free wires, the Cu content in a raw material is very small below the predetermined range so the Cu content should not be great.

Then, one can suspect that the (Si+Mn+P+S) content is small. If the content of Si and Mn imparting the deoxidation role or strength to the weld metal is small, it is difficult to obtain sound weld portions or a desired strength due to lack of the deoxidation operation. Moreover, a deficiency in the Si component directly involved in bead spreadibility of the weld metal makes the beads of the final weld portions have a convex shape, which may cause undercut in fillet welding and the mixed slag during multilayer welding.

Also, if the content of P and S, the surface activating elements, is too little, the surface tension of the molten metal is increased and wires are not easily melt in a high-temperature arc, leading to the reduction of transfer frequency in short circuit transfer mode.

Therefore, by limiting the value of {Cu/(Si+Mn+P+S)}×100 to the range of 0.10 to 0.80, the inventors could obtain copper-free wires which exhibit superior high-speed weldability under short circuit transfer conditions and excellent deposition efficiency and high melting rate under high-amperage welding conditions.

Table 1 below summarizes the comparison result of compositions, ratios of chemical composition, i.e., {Cu/(Si+Mn+P+S)}×100, surface tensions and resistivities between copper-plated wires and copper-free wires.

TABLE 1

| | | | | | | | | | Surface | |
|---|---|---|---|---|---|---|---|---|---|---|
| | Chemical components (wt %) | | | | | | | {Cu/ | tension | Resistivity |
| Division | C | Si | Mn | P | S | Cu | *Others | (Si + Mn + P + S)} × 100 | (10⁻³ N/m) | (μΩcm) |
| Copper- | 0.058 | 0.85 | 1.54 | 0.014 | 0.014 | 0.160 | Bal. | 6.62 | 1050 | 32.3 |
| plated | | | | | | | | | | |
| Copper- | 0.050 | 0.95 | 1.46 | 0.013 | 0.025 | 0.010 | Bal. | 0.41 | 980 | 33.6 |
| free | | | | | | | | | | |

(*Others: Fe and unavoidable impurities)
Surface tension test method: Inagaki (4.3 * I * V)/(thickness of burn through) * √ welding speed)
Resistivity measuring method: Impressed 100 mA to both ends of a test piece using the 4-point probe method.

According to the result shown in Table 1, copper-plated wires and copper-free wires have different components, different chemical compositions, and different resistivity values on their surfaces depending on whether they have a copper-plated layer. Because of these differences, the wires exhibit different welding speeds in low-amperage short circuit transfer mode and different weldabilities under high-amperage welding conditions.

The following now describes a scheme for controlling the dr/di value, which exhibits the surface property of the wire, to fall within the range of 1.015 to 1.515.

First of all, in order to secure the worked surface and the ratio of the total length of the worked surface, the roughness prior to the drawing process, that is, the roughness of a rod injected in the drawing process, should be kept to 0.40 μm or below (Ra). This can be achieved through hydrochloric acid pickling or sulfuric acid pickling, or through the grinding process followed by the mechanical descaling process.

Next, the drawing method and the drawing speed must be properly adjusted. Examples of the drawing method include all dry drawing (DD), drawing with all cassette roller dies (CRD), in-line method in combination of CRD and DD, and 2-step drawing methods inclusive of DD (the primary drawing)-skin pass (the secondary drawing) (SP), DD (the primary drawing)-wet drawing (the secondary drawing) (WD), CRD (the primary drawing)-SP (the secondary drawing), and CRD (the primary drawing)-WD (the secondary drawing).

In case of the in-line method the drawing speed should not exceed 1000 m/min, and in case of the 2-step drawing methods, the higher the primary drawing speed, the lower the secondary drawing speed.

Lastly, by properly managing the roughness of a rod, the drawing method and the drawing speed, the roughness of a finished wire should be within the range of 0.10-0.25 μm (Ra).

The present invention will be explained in more detail through embodiments below.

Table 2 shows surface roughnesses of the finished wire obtained by various roughnesses of rods, drawing methods and drawing speeds. At this time, hole-dies are used in addition to the CRD for drawing. In order to set the surface roughness of the finished wire within the range of 0.10 to 0.25 μm (Ra), the surface roughness of the rod should be kept to 0.40 μm or below (Ra). When the in-line method is used, the drawing speed should not exceed 1000 m/min, irrespective of using the DD, the CRD or the combination thereof. In addition, as can be seen in Table 2, when the 2-step drawing method was used, if the primary drawing speed fell within the range of 1000-1500 m/min and the secondary drawing speed was controlled to be 400 m/min or below and if the primary drawing speed fell within the range of 500-1000 m/min and the secondary drawing speed was controlled to be 600 m/min or below. In other words, the higher the primary drawing speed, the lower the secondary drawing speed. Exceptionally, if the primary and secondary drawing speeds are set too low, as can be seen in Comparative Example 18 where the primary drawing speed was set to 500 m/min or below and the secondary drawing speed was set to 200 m/min or below, the surface roughness after the drawing process is not higher than 0.10 μm (Ra) and thus, a proper combination of the drawing speeds is required.

TABLE 2

| | Surface roughness | | Drawing speed (m/min) | | Surface roughness |
|---|---|---|---|---|---|
| | before drawing | | Primary drawing | Secondary | after drawing |
| Division | (SRB) (μm) | Drawing method | (PD) | drawing (SD) | (SRA) (μm) |
| CE 1 | 0.61 | DD, | >1500 | — | 0.35 |
| CE 2 | 0.54 | CRD, | >1500 | — | 0.46 |
| CE 3 | 0.47 | CRD + DD | >1500 | — | 0.45 |
| CE 4 | 0.41 | | >1500 | — | 0.33 |
| CE 5 | 0.35 | | >1000˜1500 | — | 0.31 |
| CE 6 | 0.36 | | >1000˜1500 | — | 0.42 |
| CE 7 | 0.31 | | >1000˜1500 | — | 0.27 |
| CE 8 | 0.40 | | >1000˜1500 | — | 0.37 |
| IE 1 | 0.32 | | 500˜1000 | — | 0.21 |
| IE 2 | 0.35 | | 500˜1000 | — | 0.25 |
| IE 3 | 0.33 | | 500˜1000 | — | 0.22 |
| IE 4 | 0.34 | | 500˜1000 | — | 0.24 |
| IE 5 | 0.40 | | <500 | — | 0.24 |
| CE 9 | 0.39 | | <500 | — | 0.19 |
| IE 6 | 0.37 | | <500 | — | 0.20 |
| IE 7 | 0.29 | | <500 | — | 0.15 |
| CE 10 | 0.38 | DD(PD) + SP(SD), | >1500 | >600 | 0.35 |
| CE 11 | 0.35 | DD(PD) + WD(SD), | >1500 | 400˜600 | 0.37 |
| CE 12 | 0.33 | CRD(PD) + SP(SD), | >1500 | 200˜400 | 0.24 |
| IE 8 | 0.38 | CRD(PD) + WD(SD) | >1500 | <200 | 0.24 |
| CE 13 | 0.40 | | >1500 | <200 | 0.25 |
| CE 14 | 0.42 | | >1000˜1500 | >600 | 0.36 |
| CE 15 | 0.41 | | >1000˜1500 | 400˜600 | 0.33 |
| IE 9 | 0.35 | | >1000˜1500 | 200˜400 | 0.22 |
| IE 10 | 0.37 | | >1000˜1500 | 200˜400 | 0.20 |
| IE 11 | 0.38 | | >1000˜1500 | <200 | 0.15 |
| IE 12 | 0.34 | | >1000˜1500 | <200 | 0.22 |
| CE 16 | 0.46 | | 500˜1000 | >600 | 0.31 |
| IE 13 | 0.39 | | 500˜1000 | 400˜600 | 0.21 |
| IE 14 | 0.33 | | 500˜1000 | 200˜400 | 0.24 |
| IE 15 | 0.39 | | 500˜1000 | 200˜400 | 0.23 |
| IE 16 | 0.34 | | 500˜1000 | <200 | 0.19 |
| IE 17 | 0.28 | | 500˜1000 | <200 | 0.16 |
| CE 17 | 0.37 | | <500 | >600 | 0.27 |
| IE 18 | 0.37 | | <500 | 400˜600 | 0.25 |
| IE 19 | 0.32 | | <500 | 200˜400 | 0.18 |
| IE 20 | 0.30 | | <500 | 200˜400 | 0.24 |
| CE 18 | 0.29 | | <500 | <200 | 0.09 |

(CE: Comparative Example,
IE: Invention Example)

Table 3 below shows the results of measurement on the cross-sectional surface shape of the wire, ratio (dr/di) of the actual lengths of a circular arc (dr) to the apparent lengths of a circular arc (di), the amounts of the lubricant residues, the amounts of surface treatment agents used, and feedabilities and arc stabilities of the respective wires.

TABLE 3

| | | | | Applied amount of | | |
|---|---|---|---|---|---|---|
| | Cross-sectional | | Amount of lubricant | surface treatment | | |
| Division | surface shape | dr/di | residue(g/W · Kg) | agent(g/W · Kg) | Feedability | Arc stability |
| CE 1 | [symbol] | 1.529 | 0.64 | 0.33 | X | X |
| CE 2 | [symbol] | 1.536 | 0.66 | 0.12 | X | X |
| CE 3 | [symbol] | 1.545 | 0.75 | 0.03 | X | X |
| CE 4 | [symbol] | 1.519 | 0.52 | 0.24 | X | X |
| CE 5 | [symbol] | 1.521 | 0.57 | 0.42 | □ | X |
| CE 6 | [symbol] | 1.541 | 0.72 | 0.02 | X | X |
| CE 7 | [symbol] | 1.516 | 0.55 | 0.35 | □ | X |
| CE 8 | [symbol] | 1.533 | 0.68 | 0.01 | X | X |
| IE 1 | [symbol] | 1.515 | 0.49 | 0.56 | ◯ | ◯ |
| IE 2 | [symbol] | 1.479 | 0.50 | 0.70 | ◯ | ◯ |
| IE 3 | [symbol] | 1.467 | 0.44 | 0.45 | ◯ | ◯ |
| IE 4 | [symbol] | 1.415 | 0.41 | 0.37 | ◯ | ◯ |
| IE 5 | [symbol] | 1.366 | 0.42 | 0.22 | ◯ | ◯ |
| CE 9 | [symbol] | 1.295 | 0.37 | 0.75 | □ | ◯ |
| IE 6 | [symbol] | 1.325 | 0.35 | 0.15 | ◯ | ◯ |
| IE 7 | [symbol] | 1.221 | 0.34 | 0.09 | ◯ | ◯ |
| CE 10 | [symbol] | 1.558 | 0.82 | 0.21 | X | X |
| CE 11 | [symbol] | 1.524 | 0.71 | 0.35 | X | X |
| CE 12 | [symbol] | 1.518 | 0.54 | 0.41 | ◯ | X |
| IE 8 | [symbol] | 1.154 | 0.31 | 0.31 | ◯ | ◯ |
| CE 13 | [symbol] | 1.517 | 0.53 | 0.52 | ◯ | X |
| CE 14 | [symbol] | 1.602 | 0.85 | 0.33 | X | X |
| CE 15 | [symbol] | 1.534 | 0.61 | 0.34 | X | X |
| IE 9 | [symbol] | 1.181 | 0.38 | 0.47 | ◯ | ◯ |
| IE 10 | [symbol] | 1.289 | 0.39 | 0.61 | ◯ | ◯ |
| IE 11 | [symbol] | 1.023 | 0.30 | 0.03 | ◯ | ◯ |
| IE 12 | [symbol] | 1.310 | 0.33 | 0.11 | ◯ | ◯ |
| CE 16 | [symbol] | 1.518 | 0.52 | 0.45 | X | X |
| IE 13 | [symbol] | 1.016 | 0.28 | 0.64 | ◯ | ◯ |
| IE 14 | [symbol] | 1.027 | 0.36 | 0.55 | ◯ | ◯ |
| IE 15 | [symbol] | 1.382 | 0.42 | 0.28 | ◯ | ◯ |
| IE 16 | [symbol] | 1.021 | 0.33 | 0.42 | ◯ | ◯ |
| IE 17 | [symbol] | 1.261 | 0.29 | 0.18 | ◯ | ◯ |
| CE 17 | [symbol] | 1.519 | 0.54 | 0.54 | X | X |
| IE 18 | [symbol] | 1.026 | 0.21 | 0.38 | ◯ | ◯ |
| IE 19 | [symbol] | 1.015 | 0.28 | 0.05 | ◯ | ◯ |
| IE 20 | [symbol] | 1.018 | 0.32 | 0.07 | ◯ | ◯ |
| CE 18 | Flat surface | 1.013 | 0.09 | 0.20 | □ | ◯ |

IE: Invention Example,
CE: Comparative Example

The cross-sectional surface shape of the wire was taken from an image of the cross section of the wire at 90 degrees in the longitudinal direction of the wire, which is magnified 1,000 times in the SEM micrograph, wherein the mark [symbol] indicates an irregular surface having no worked surface, the mark [symbol] indicates a combined surface of the present invention, which consists of a worked surface and depressions of the negative direction (toward the center of the wire) with respect to the worked surface formed in the circumferential direction, and the FS indicates a flat surface only consisting of a worked surface. As can be seen in Table 3, the combined surface of the present invention is obtained when the surface roughness of the finished wire among the wires of Table 2 falls within the range of 0.10 to 0.25 μm (Ra).

The following now describes how to measure the ratio of the actual length (dr) of a circular arc to the apparent length (di) of a circular arc, (dr/di).

First of all, the actual length of a circular length (dr) to be measured using an image analyzing system (Image-pro plus 4.5, Media cybernetics) at the magnification of ×1,000. Here, the actual length of a circular arc obtained with the image analyzing system corresponds to a sum of the circumferential length of depressions formed into the wire surface and the length of the worked surface.

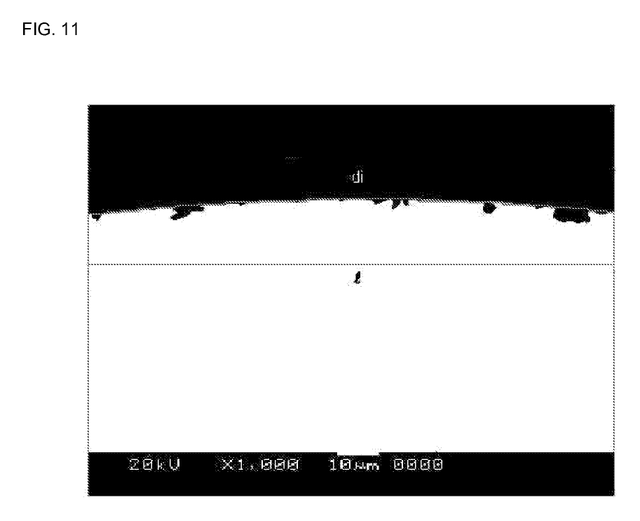

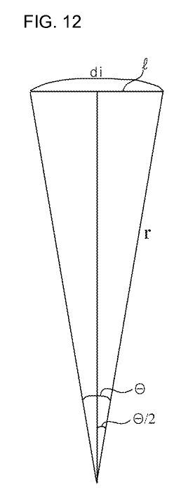

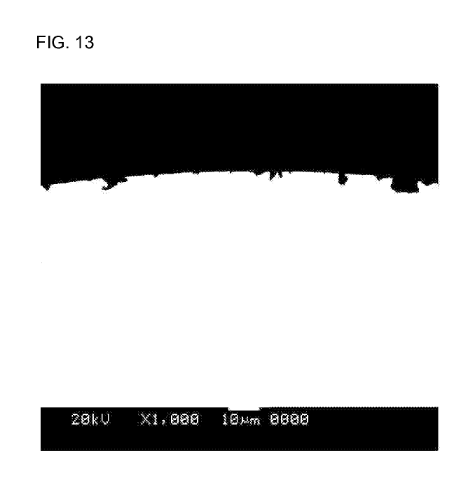

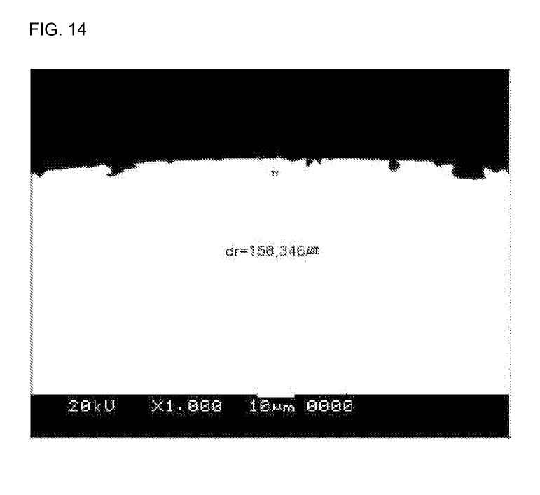

FIGS. 13 and 14 are SEM micrographs, showing an image before the measurement of the actual length of a circular arc and an image after the measurement, respectively. To calculate the apparent length of a circular arc (di), a length of a subtense (/) at the limited measurement area of the wire was measured using the image analyzing system at the magnification of ×1,000. FIG. 11 is a picture showing such image required for calculating the apparent length of a circular arc (di). Once the length of the subtense was obtained, as shown in FIG. 12, the internal angle (O) between the radius (r) of the wire and the subtense can be calculated by applying the trigonometric function. The apparent length of a circular arc (di) equals to the radius (r) of the wire x the internal angle (θ) of the circle. In other words, the apparent length of a circular arc (di) can be calculated using the radius (r) of the wire obtained by measuring the real wire diameter.

Actual measurement using the image analyzing system was performed as described below.

First, finished wire samples were extracted, and removed of contaminants on the surface thereof through ultrasonic cleaning in an organic solvent. The wire samples were heated to 400° C. for 2-3 hours, thereby forming an oxidized thin film on the surface of the wire samples. Subsequently, each of the wire samples having the oxidized thin film thereon was subjected to a mounting process using a thermosetting resin at 90 degrees vertically in the longitudinal direction of the wire, followed by polishing the wire samples. Finally, the polished cross section of each wire was observed using back scattering electrons of the SEM, and the apparent length of a circular arc and the actual length of a circular arc were measured using the image analyzing system to calculate the dr/di value. At this time, the magnification was ×1,000.

Measurement of the applied amount of the surface treatment agent was carried out as follows:

1. Preparing a wire sample having a length of 4-6 cm and a weight of 50-80 g.

2. Preparing a solvent, CCl₄ of 150 ml, in a beaker.

3. Measuring the weight (Wb) of the wire sample before degreasing on 1 g/10,000 scales.

4. Inputting the wire sample into the beaker containing CCl₄, and degreasing of surface treatment oil from the wire sample for 10 minutes while stirring the wire samples two or three times.

5. Drying the degreased wire sample for 10 minutes within a dry oven, and cooling the wire sample to room temperature in a desiccator.

6. Measuring the weight (Wa) of the wire sample after degreasing on 1 g/10,000 scales.

7. Calculating the applied amount of the surface treatment agent based on measured values of Wb and Wa according to the following Equation 3.
Applied amount of surface treatment agent (g/W.kg)={(Wb−Wa)/Wa}×1000 [Equation 3]

Measurement of the amount of lubricant residue on the surface of the wire was carried out as follows:

1. Carrying out the same procedure with the 1-6 steps used in the measurement of the applied amount of the surface treatment agent.

2. Designating the weight (Wa) of the 6 step as the weight (Wb′).

3. Depositing the wire sample for 20 minutes in 5% anhydrous chromic acid (CrO₃) maintained at 70° C.

4. Washing the degreased wire sample with boiled water and then alcohol.

5. Drying the wire sample washed with alcohol for 10 minutes within a dry oven, and cooling it to room temperature in a desiccator.

6. Measuring the weight (Wa′) of the wire sample after degreasing on 1 g/10,000 scales.

7. Calculating the amount of the lubricant residue based on measured values of Wb′ and Wa′ according to the following Equation 4.
Amount of lubricant residue (g/W.kg)={(Wb′−Wa′)/Wa′}×1000 [Equation 4]

The following now describes a method of evaluating the arc stability and the feedability.

Table 4 shows the welding conditions for evaluating the arc stability, in which a straight feeding cable having a length of 3 m was used for evaluating the arc stability.

TABLE 4

| Welding conditions for evaluation of arc stability | | Welding position |
|---|---|---|
| Current (A): 210 | Voltage (V): 23 | Bead on plate |
| Speed (cm/min): 120 | Welding time (sec): 12 | |
| Shielding gas: 100% CO₂ | Gas flow rate (l/min): 20 | |

According to the arc stability evaluation results, when the weight of spatters having a particle size of 1 mm or greater exceeds 1.6(%) or when the ratio(%) of the total weight of spatters with respect to the total weight of the deposited metal exceeds 9(%), the arc stability was regarded to be poor, which is indicated “x” in the table, and when the weight of the spatter is below the value as mentioned above, the arc stability was regarded to be excellent, which is indicated “◯” in the table. Wires used for evaluating the arc stability were JIS Z 3312 YGW 12 (AWS A5.18 ER70S-6) 1.2 mm.

Table 5 shows the welding conditions for evaluating the feedability, in which a new feeding cable having a length of 5 m and wound two times (ring shape) to have a diameter of 300 mm was used for evaluating the feedability.

TABLE 5

| Welding conditions for evaluation of feedability | | Welding position |
|---|---|---|
| Current (A): 420 | Voltage (V): 44 | Bead on plate, |
| Speed (cm/min): 50 | Welding time (sec): - | Zigzag weaving |
| Shielding gas: 100% CO₂ | Gas flow rate (l/min): 20 | |

According to the result of evaluation for the feedability, when a continuous welding time was shorter than 80 sec, feeding was not smoothly performed, resulting in failure of welding, and the feedability was regarded to be poor, which is indicated “x” in the table. Meanwhile, when the continuous welding time was 100 sec or longer, the feedability was regarded to be excellent, which is indicated “◯” in the table. Lastly, when the continuous welding time is in the range of 80-100 sec, the feedability was regarded to be normal, which is indicated “Δ” in the table. Wires used for evaluating the feedability were also JIS Z 3312 YGW 12 (AWS A5.18 ER70S-6) 1.2 mm.

Although the wires used for the example of the present invention were JIS Z 3312 YGW12 (AWS A5.18 ER70S-6) 1.2 mm, JIS YGW 11, 14, 15, 16, 18 and 21 wires also yielded the same results.

As can be seen in Table 3, Comparative Examples 1-3, 4, 10, 11, 14, 15, 16 and 17 (including a high speed drawing condition of the secondary drawing) have surface shapes of [symbol] on the cross section of the wire due to high speed drawing, thereby resulting in poor feedability and arc stability even with a proper amount of the surface treatment agent within the range of the present invention. In addition, as the ratio dr/di exceeds the set range of the present invention, the amount of the lubricant residue exceeded its range and the amount of spatter formation was increased. This has led to an unstable arc. Comparative Examples 5, 7, 12, and 13 have surface shapes of [symbol] on the cross section of the wire according to stable drawing conditions and proper amounts of the surface treatment agent within the range of the present invention were applied thereto. Although marginally good feedability was ensured in this way, the ratio dr/di exceeded the set range of the present invention. That is, because there are many other surfaces except the worked surface, the contact between the contact tip and the wire during welding was not stable and at the same time the amount of spatter formation was increased due to the increase in the amount of the lubricant residue during the drawing process.

Particularly, in case of Comparative Examples 5, 7, 12, and 13, even though the surface roughnesses of the wire before or after drawing were secured within the range of the present invention, since the drawing rates were not appropriately controlled, the ratios of dr/di exceeded the range of the present invention. Comparative Examples 6 and 8 has a surface shape of [symbol] on the cross section of the wire due to a high speed drawing and at the same time the amount of the surface treatment agent applied thereto deviated from the range of the present invention, thereby resulting in poor feedability and inferior arc stability. As the ratio dr/di exceeded the set range of the present invention, the amount of spatter formation was resultantly increased due to the increase in the amount of the lubricant residue.

Comparative Example 9 has a surface shape of [symbol] on the cross section of the wire according to stable drawing conditions and at the same time the radio dr/di and the amount of the lubricant residue lie within the ranges of the present invention, thereby exhibiting superior arc stability. However, because the amount of the surface treatment agent exceeded the range of the present invention, the wire slip problem occurred in feeder sections upon welding, and thus the feedability was not secured. Comparative Example 18 has a flat surface on the cross section of the wire, the contact between the contact tip and the wire during welding was stable and arc stability was secured. Although the applied amount of the surface treatment agent was also within the range of the present invention, however, due to the flat surfaces on the cross section of the wires, the wire slipped in the feeder sections upon welding, leading to poor feedability.

Meanwhile, by optimally adjusting the surface roughness before drawing, the drawing method, the drawing rate, and the surface roughness after drawing within their respective ranges of the present invention, Invention Examples 1-20 could have the surface shapes [symbol] in the negative direction (toward the center of the wire) with respect to the worked surface, and the ratio (dr/di) of the actual length of a circular arc to the apparent length of a circular arc were controlled to fell within the range of the present invention. Additionally, the amounts of the lubricant residues were also within the range of the present invention, which in turn reduced the amount of spatter generation.

In addition, the applied amount of the surface treatment agent was adjusted to fall within the range of 0.03 to 0.70 g/W·kg, thereby satisfying both feedability and arc stability.

The following now describes an embodiment for securing copper-free wires, which exhibit a superior high-speed weldability even in low-amperage short circuit transfer mode and excellent deposition efficiency and high melting rate under high-current welding conditions.

As explained so far, the amount of fume, spatter and slag formation could be suppressed by properly controlling the surface properties of the wire, by managing the amount of the lubricant residue on the wire surface and by applying only the liquid surface treatment agent. The same results were obtained by suppressing the Cu content, that is, using copper-free wires, and by adjusting the composition of Si and Mn contents, thereby improving deposition efficiency. Thus, the objects of the present invention were attained by improving the melting rate through the adjustment of chemical components and composition thereof as shown in Table 6 below.

TABLE 6

| | | | | | | | | {Cu/ | | | | | |
|---|---|---|---|---|---|---|---|---|---|---|---|---|---|
| | | | | | | | | Si + | | Surface | | | Melting |
| | Chemical component | | | | | | | Mn + P + | dr/ | tension | Resistivity | Deposition | rate |
| Division | C | Si | Mn | P | S | Cu | Others | S)} × 100 | di | (10⁻³ N/m) | (μΩcm) | efficiency (%) | (g/min) |
| IE 1 | 0.050 | 0.95 | 1.46 | 0.013 | 0.025 | 0.010 | Bal. | 0.41 | 1.020 | 980 | 33.6 | 98.8 | 129 |
| IE 2 | 0.080 | 0.89 | 1.47 | 0.014 | 0.010 | 0.010 | Bal. | 0.42 | 1.018 | 1020 | 33.4 | 98.5 | 125 |
| IE 3 | 0.055 | 0.91 | 1.43 | 0.010 | 0.022 | 0.010 | Bal. | 0.42 | 1.325 | 1010 | 34.1 | 98.8 | 127 |
| IE 4 | 0.061 | 0.87 | 1.48 | 0.013 | 0.013 | 0.007 | Bal. | 0.29 | 1.231 | 1015 | 33.3 | 98.7 | 126 |
| IE 5 | 0.060 | 0.96 | 1.46 | 0.011 | 0.015 | 0.004 | Bal. | 0.16 | 1.450 | 990 | 33.9 | 98.8 | 129 |
| IE 6 | 0.066 | 0.82 | 1.48 | 0.010 | 0.013 | 0.012 | Bal. | 0.52 | 1.501 | 1005 | 34.1 | 98.6 | 124 |
| IE 7 | 0.051 | 0.76 | 1.53 | 0.016 | 0.019 | 0.017 | Bal. | 0.73 | 1.025 | 1017 | 33.1 | 98.5 | 123 |
| IE 8 | 0.058 | 0.79 | 1.57 | 0.016 | 0.011 | 0.013 | Bal. | 0.54 | 1.510 | 997 | 34.3 | 98.7 | 128 |
| IE 9 | 0.071 | 0.61 | 1.25 | 0.014 | 0.010 | 0.005 | Bal. | 0.27 | 1.380 | 1002 | 33.8 | 98.6 | 124 |
| IE 10 | 0.074 | 0.58 | 1.19 | 0.012 | 0.016 | 0.014 | Bal. | 0.78 | 1.490 | 1015 | 34.1 | 98.5 | 121 |
| CE 1 | 0.066 | 0.85 | 1.42 | 0.011 | 0.008 | 0.180 | Bal. | 7.86 | 1.005 | 1100 | 31.8 | 98.3 | 115 |
| CE 2 | 0.050 | 0.95 | 1.46 | 0.013 | 0.015 | 0.160 | Bal. | 6.56 | 1.010 | 1080 | 32.1 | 98.4 | 115 |
| CE 3 | 0.058 | 0.85 | 1.54 | 0.014 | 0.014 | 0.160 | Bal. | 6.62 | 1.011 | 1050 | 32.3 | 98.3 | 116 |
| CE 4 | 0.058 | 0.79 | 1.57 | 0.016 | 0.011 | 0.200 | Bal. | 8.38 | 1.009 | 1105 | 32.0 | 98.2 | 113 |
| CE 5 | 0.071 | 0.61 | 1.25 | 0.014 | 0.010 | 0.210 | Bal. | 11.15 | 1.007 | 1075 | 31.9 | 98.1 | 117 |
| CE 6 | 0.065 | 0.66 | 1.23 | 0.014 | 0.011 | 0.007 | Bal. | 0.37 | 1.010 | 1020 | 33.3 | 98.4 | 118 |
| CE 7 | 0.051 | 0.89 | 1.44 | 0.012 | 0.022 | 0.007 | Bal. | 0.30 | 1.570 | 1010 | 34.5 | 98.2 | 117 |
| CE 8 | 0.038 | 0.74 | 1.58 | 0.012 | 0.008 | 0.008 | Bal. | 0.34 | 1.630 | 1024 | 34.8 | 98.3 | 119 |
| CE 9 | 0.071 | 0.91 | 1.49 | 0.011 | 0.011 | 0.038 | Bal. | 1.57 | 1.550 | 1035 | 33.9 | 98.1 | 119 |
| CE 10 | 0.074 | 0.86 | 1.49 | 0.006 | 0.009 | 0.036 | Bal. | 1.52 | 1.320 | 1040 | 33.3 | 98.4 | 114 |

*Others: Fe and unavoidable impurities

Welding conditions for measuring deposition efficiency and melting rate are illustrated in Table 7 below, and the deposition efficiency and the melting rate were calculated in accordance with Equations 5 and 6 as follows:
Deposition efficiency (%)=(Weight of deposited metal/Weight of rod consumed during welding)×100 [Equation 5]
Melting rate (g/min)=(Weight of rod consumed during welding/Arc time) [Equation 6]

TABLE 7

| Welding conditions | | |
|---|---|---|
| for measuring deposition efficiency and melting rate | | Welding position |
| Current (A): 350 | Voltage (V): 32 | Bead on plate |
| Speed (cm/min): 30 | Welding time (sec): 60 | |
| Gas: 80% Ar - 20% CO₂ | Gas flow rate (l/min): 20 | |

As can be seen in the results of Table 6, when the wire composition ratio {Cu/(Si+Mn+P+S)}×100 lied within the range of 0.10 to 0.80 and when the ratio dr/di satisfied the set range of 1.015 to 1.515, superior arc stability and excellent weldability were obtained. Moreover, surface tension of the molten metal was lowered and at the same time its resistivity was increased. As a result, high speed weldability in low-amperage short circuit transfer mode and superior arc stability under high-current welding conditions could be secured.

On the other hand, when the wire composition ratio {Cu/(Si+Mn+P+S)}×100 did not satisfy the range of 0.10 to 0.80 and when the ratio dr/di was deviated from the set range of 1.015 to 1.515, the wire feedability or the arc stability was deteriorated. In this case, since the content of P and S, the surface activating elements which serve to lower the surface tension of the molten metal was small, the surface tension was high. Moreover, since the Cu content was reduced, it is difficult to properly control the surface tension. In case of copper-plated wires, the Cu content is increased due to the Cu-plated layer existing therein, and this in turn reduces the resistivities, the deposition efficiency and the rate of melting.

Control Examples 1-5 are copper-plated wires. As mentioned before, these wires contain more than a predetermined amount of Cu because of the copper-plated layer existing therein. Unlike copper-free wires in Invention Examples 1-10, resistivities of the copper-plated wires were small and the surface tensions of the molten metals were increased. In result, the wires exhibit low melting rates and relatively lower rates of weld materials becoming deposited metals (that is, low deposition efficiencies) than those of the copper-free wires. Therefore, it was impossible to attain high-speed weldability in short circuit transfer mode and superior arc stability under high-current welding conditions.

Control Examples 6-8 are copper-free wires. As can be seen in Table 6, even though the wire composition ratio {Cu/(Si+Mn+P+S)}×100 lied within the set range of 0.10 to 0.80, the ratio dr/di which is the surface property control value was deviated from the set range of 1.015 to 1.515. Consequently, the wire feedability and the arc stability, which are basic properties of welding wires, could not be secured or deposition inhibiting factors were generated. This made it difficult to obtain desired welding properties.

Control Examples 9 and 10 are also copper-free wires. However, due to an excessive Cu content, the wire composition ratio {Cu/(Si+Mn+P+S)}×100 exceeded the set range of 0.10 to 0.80. Resultantly, the surface tensions of the molten metals were increased and desired welding properties could not be obtained.

In short, the inventors succeeded in manufacturing copper-free wires as in Invention Examples 1-10, which exhibit high speed weldability even in low-amperage short circuit transfer mode and superior arc stability under high-current welding conditions, by properly controlling the surface properties of those wires and by adjusting their chemical components and compositions.

As apparent from the description, according to the present invention, the copper-free wire for gas-shielded arc welding comes into stable contact with the contact tip without the copper-plated layer on the surface of the wire, so that the copper flakes are not clogged in the conduit cable and the contact tip upon welding for a long time, thereby providing excellent arc stability, stable wire feedability and reduction in spatter formation.

Moreover, the copper-free wires of the present invention resultantly increase the frequency of occurrence of resistance heat between the contact tip and the wire and at the same time offer high speed weldability in low-amperage short circuit transfer mode and superior arc stability under high-current welding conditions, which benefits are achieved by properly controlling the surface properties of those wires and by adjusting their chemical components and compositions.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A copper-free wire for gas-shielded arc welding, wherein the wire has a flat-shaped worked surface, and depressions of a negative direction (toward the center of the wire) with respect to the worked surface formed in a circumferential direction of the surface; wherein a ratio of an actual length (dr) of a circular arc to an apparent length (di) of a circular arc, (dr/di), lies within a range of 1.015 to 1.515; and wherein a chemical composition ratio {Cu/(Si+Mn+P+S)}×100 lies within a range of 0.10 to 0.80.

2. The copper-free wire as set forth in claim 1, wherein an amount of lubricant residue existing on the wire surface is not greater than 0.50 g per unit kg of the wire mass.

3. The copper-free wire as set forth in claim 1 or 2, wherein the wire surface is coated with a surface treatment agent of 0.03-0.70 g per unit kg of the wire mass.

4. The copper-free wire as set forth in claim 3, wherein the surface treatment agent consists of at least one of animal oil, vegetable oil, mineral oil, mixed oil, and synthesized oil.
